(19) United States
(12) Patent Application Publication
(10) Pub. No.: US 2012/0064250 A1
(43) Pub. Date: Mar. 15, 2012

(54) METHOD AND APPARATUS FOR TRANSPORTING A PRINT SUPPORT

(75) Inventors: Andrea BACCINI, Treviso (IT); Thomas MICHELETTI, Treviso (IT); Marco GAJOTTO, Treviso (IT)

(73) Assignee: Applied Materials ITALIA S. R. L., San Biago Di Callalta (Treviso) (IT)

(21) Appl. No.: 13/228,389

(22) Filed: Sep. 8, 2011

Related U.S. Application Data
(60) Provisional application No. 61/441,676, filed on Feb. 11, 2011.

(30) Foreign Application Priority Data
Sep. 13, 2010 (IT) UD2010A000163

(51) Int. Cl. B05D 1/32; B05C 13/00; B65G 15/58

(52) U.S. Cl. 427/282; 198/688.1; 198/689.1; 118/500

(57) ABSTRACT

The present invention generally relates to a transport unit for transporting a print support, or substrate, through a plant that deposits print tracks on a surface of the print support. The plant has at least one print station having at least one print head to deposit the print track onto the print support according to a predetermined pattern. The transport unit comprises a transport element having a transport surface facing, during use, toward the print head and on which the print support is disposed during processing. The transport surface comprises a portion covered with an adhesive surface layer upon which the print support is positioned.

### CROSS-REFERENCE TO RELATED APPLICATIONS

This application claims priority to Italian Patent Application number UD2010A000163, filed Sep. 13, 2010, entitled “Unitai Per Iltransporto Di Un Supporto Di Stampa In Un Impianto Per La Deposizione Di Tracce Di Stampa Su Tale Supporto Di Stampa, E Relativo Procedimento Per Il Transporto”, and also the benefit of U.S. Provisional Patent Application Ser. No. 61/441,676, filed Feb. 11, 2011, entitled “Method And Apparatus For Transporting A Print Support”, which are both herein incorporated by reference.

### BACKGROUND OF THE INVENTION

1. Field of the Invention

The present invention generally relates to a transport unit for transporting a print support in a plant for depositing print tracks on the print support and a method for transporting the print support through the plant for depositing the print tracks.

2. Description of the Related Art

It is well known to deposit one or more print tracks in predetermined patterns on a suitable substrate support using one or more successive printing steps. The printing steps may include silk-screening, ink jetting, laser printing or other similar processes. Suitable substrate supports include wafers with a silicon or alumina base. Such processes are typically automated by electronic processors, peripheral hardware or other electronic apparatus. Typically, each print track is deposited by a corresponding print station. These print stations may be disposed in succession on a single line. Each print station may be provided with at least one print head on which one print net/mask is mounted, for example for silk-screen printing. Each print track consists of a print paste or material which is suitably released by the print head onto the print support according to a predetermined printing pattern.

Substrates may be transported on conveyor belts made of porous material. During transport, the substrates may be suctioned to the conveyor belt by drawing a vacuum from below the belt. By transporting the substrates in such a manner, a predetermined position of the substrate may be maintained and the center of the print head will be centered on the substrate with respect to the print head. In some instances, the substrate may have holes therethrough. If the substrates have holes therethrough, the paste deposited by the print head is drawn inside the holes until the paste exits from the surface opposite the one where it was deposited due to the vacuum. Therefore, the conveyor belt will become indelibly stained with the print paste and must be frequently replaced to prevent the stains from adversely affecting the deposition on the substrates, such as imperfections in printing and causing unwanted conductive conditions on various surfaces of the substrates. Changing conveyor belts increases the manufacturing costs. Additionally, there is a high possibility of errors in positioning and in making the subsequent wafers.

Therefore, there is a need in the art to transport a print support in a plant for depositing print tracks on the print support, which minimizes both the downtime and the costs associated with replacing the conveyor belt. There is also a need in the art for reducing the negative effects of printing paste pulled through holes in the substrate and of incorrect positioning of the conveyor belt.

### SUMMARY OF THE INVENTION

The present invention is set forth and characterized in the independent claims, while the dependent claims describe other characteristics of the invention or variants to the main inventive idea.

In one embodiment, an apparatus includes a transport device having at least a transport surface and an adhesive surface layer disposed on at least a portion of the transport surface at a location corresponding to where a print support (also referred to herein a substrate) is to be positioned during processing.

Embodiments of the invention may further provide a transportation apparatus, comprising a transport device having a transport surface, an adhesive layer disposed over at least a portion of the transport surface, wherein the adhesive layer has a contact surface on which at least a portion of a substrate can be received, a separation device having an edge that is positioned to separate a substrate that is disposed on the contact surface, and a mechanical actuator that is configured to move the adhesive layer relative to the separation device.

Embodiments of the invention may further provide a method for transporting a substrate, comprising disposing a substrate on a contact surface of an adhesive layer that is disposed over at least a portion of a transport surface of a transport device, moving the substrate and the transport device towards a print head, and positioning a printing mask disposed in the print head relative to the adhesive layer using an actuator.

In another embodiment, a method for transporting a print support in a plant for depositing print tracks on said print support, in which the plant is provided with at least a print station having at least a print head able to deposit said at least one print track onto said print support according to a predetermined pattern is disclosed. The method includes disposing a print support on a transport device having at least a portion covered with at least one adhesive surface layer, moving a transport device having at least a transport surface toward said print head and depositing material onto the print support from the print head.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic layout of a plant for depositing print tracks on a print support, in which a transport unit according to the present invention is provided.

FIG. 2 is a schematic layout of a plant according to another embodiment.

FIG. 3 is a schematic lateral view, partial and sectioned, of the transport unit according to one embodiment.

FIG. 4 is a schematic lateral view, partial and sectioned, of the transport unit according another embodiment.

FIG. 5 is a schematic sectioned lateral view of an enlarged detail of the transport unit of FIG. 3 according to one embodiment.

FIG. 6 is a schematic sectional lateral view of an enlarged detail of the transport unit of FIG. 3 according to another embodiment.

FIG. 7 is a schematic top view of an adhesive surface layer on a conveyor belt of a transport unit according to one embodiment.

FIG. 8 is a schematic top view of an adhesive surface layer on a conveyor belt of a transport unit according to another embodiment.

FIG. 9 is a schematic top view of an adhesive surface layer on a conveyor belt of a transport unit according to another embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments discussed herein relate to a print support for use in a plant that deposits print tracks on the print support. Suitable methods for depositing the print tracks include silk-screening, ink jetting and laser printing. The methods are generally used to print conductive tracks comprising a multiple layer pattern by a printing process that is performed on one or more surfaces of a print support. The term “print support” as used herein will generally include various types of substrates, such as, for example, plate elements used to form electronic devices, wafers, foils, green tape circuits or substrates with a silicon base that can be used to produce photovoltaic cells. However, it is to be understood that a print support, or substrate, may also include other types of print supports typical of other fields in which a printing operation is utilized.

In accordance with the above purposes, a transport unit according to the present invention is utilized in a plant for depositing print tracks on a print support. The plant is provided with at least one print station having at least one print head able to deposit on the print support at least one print track in a predetermined pattern. The transport unit comprises a transport device having at least one transport surface. The transport surface faces toward the print head during processing and is the surface upon which the print support is disposed when transported.

According to one embodiment of the invention, the transport surface comprises at least a portion that is covered by at least one adhesive layer on which the print support is to be directly positioned. Suitable adhesives that may be used include polyvinyl chloride and polypropylene. The adhesive layer maintains the print support in a predetermined position with respect to the transport device during the transport through the print station. Additionally, the adhesive layer maintains the print support in a predetermined position during the printing step to help assure that the printed material is correctly positioned on the substrate. Thus, correct positioning of the print support with respect to the transport device is obtained by the adhesive surface layer as opposed to suction through the transpiring material as has been conventionally done. It is to be understood that the term “non-transpiring” as used herein refers to a material which is impermeable to a gas and to suction, i.e., a gas disposed on a first side of the material cannot be attracted by suction applied to a side of the material opposite to the first side. This means that, when the substrate is upon this material, it is retained by the adhesive, not by the suction from below. Thus, the term “transpiring” as used herein is the opposite of “non-transpiring”. Due to the use of the adhesive layer, even if the print support has through holes, the print paste used to define the print tracks is prevented from being drawn through the holes and depositing on the contact surface or transport surface of the transport device. Therefore, the risk that the print paste can deposit and/or stain the transport surface of the transport device is reduced or even eliminated. Thus, the risk of the print paste interfering with the printing process of subsequent print supports is reduced or even eliminated. Similarly, the print paste is prevented from interfering with the printing method of the support for which it was delivered. The embodiments discussed herein reduce to a minimum the downtimes for replacing the transport device, and therefore with lower costs and management expenses associated with operation. Additionally, repeatability from print support to print support is increased due to an increase in uniformity. Another advantage of the transport device discussed herein is the transport device does not need to create vacuum (e.g., a pressure below atmospheric pressure) and/or suction in order to keep the print support adherent to the transport surface.

In one embodiment, the transport device includes a conveyor belt covered on its transport surface with the adhesive surface layer. The adhesive surface layer comprises a water-repellent and non-transpiring material. The conveyor belt may be tensed and moved by two reels, such as a feed reel and a recovery reel, that are disposed upstream and downstream of the print head. The adhesive surface layer is disposed on the transport surface of the conveyor belt. The conveyor belt may have portions of its transport surface on which the adhesive surface layer is provided and portions where no adhesive surface layer is provided. During processing, a print support is disposed on each portion having the adhesive surface layer. In one embodiment, each portion of the conveyor belt is independently mobile with respect to the adjacent portions, so as to allow specific adjustment of each print support before the printing steps.

In one embodiment, the transport unit comprises a suction unit disposed below the conveyor belt, at least in a location below a corresponding print station, to ensure the correct position of the print support during the printing steps. In another embodiment, an independent adhesive belt, provided with the adhesive surface layer thereon, is disposed on the transport surface of the conveyor belt. According to one embodiment, the adhesive belt is disposed on only one surface of the conveyor belt. In another embodiment, the adhesive belt is disposed at least partly on both surfaces of the conveyor belt. In one embodiment, the conveyor belt is a closed ring and the adhesive belt is deposited onto the transport surface of the conveyor belt at a position upstream of the print head and removed at a position downstream of the print head. In such an embodiment, the transport unit can comprise a suction unit which is disposed below the transport surface to keep the adhesive belt close to the transport surface of the conveyor belt.

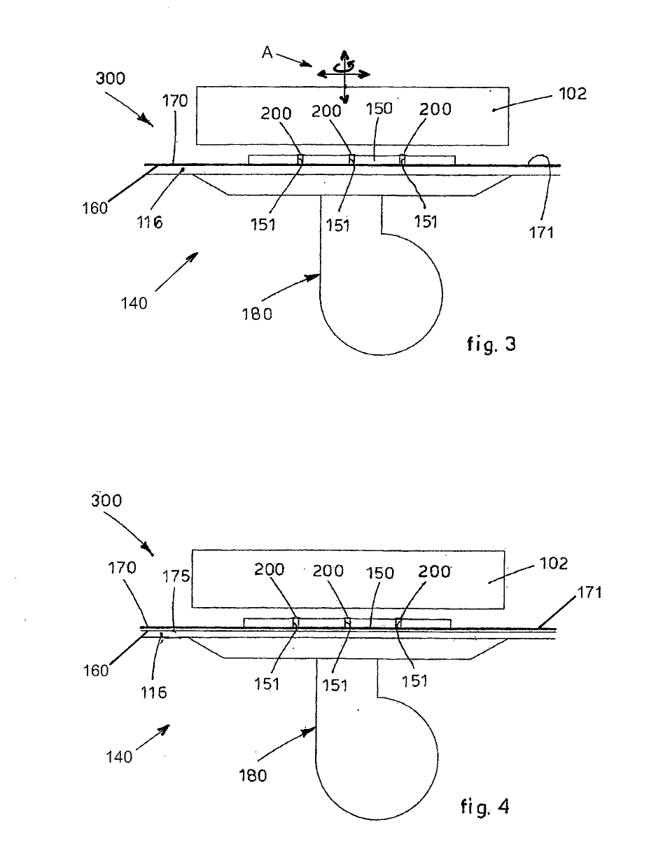

In another embodiment, the transport device includes a transport shuttle able to support and transport a print support through the operating stations of the plant. The transport shuttle has a conveyor belt 116 (FIGS. 3-4) that has a transport surface 160 with the adhesive layer 170 disposed thereon. The transport shuttle comprises a suction unit 180 (FIGS. 3-4) which is disposed below the transport surface to provide a suction to keep either the conveyor belt with its adhesive surface layer in the correct operating position or to keep an independent adhesive belt, which is discussed further below, adjacent to the transport surface of the conveyor belt.

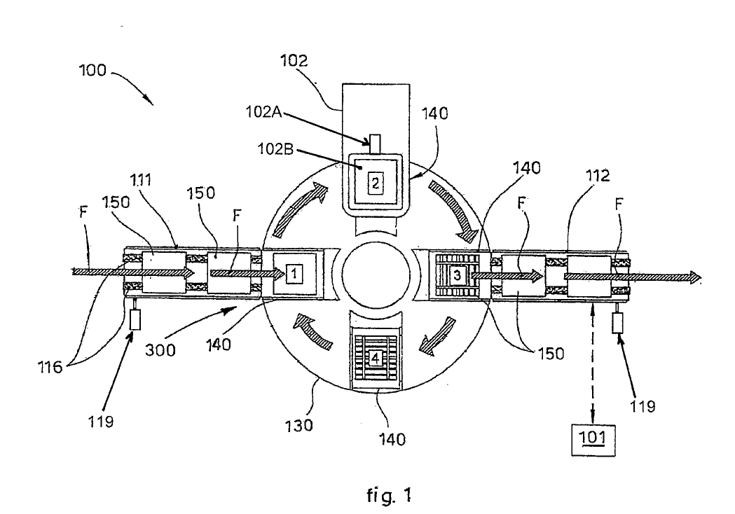

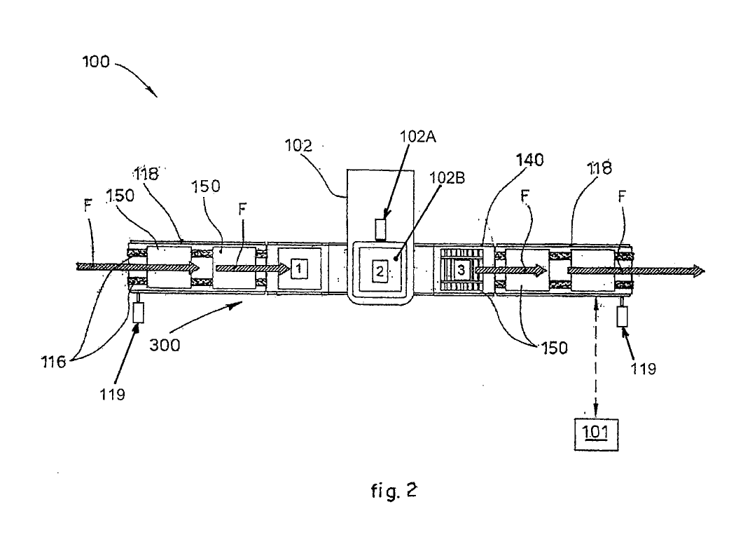

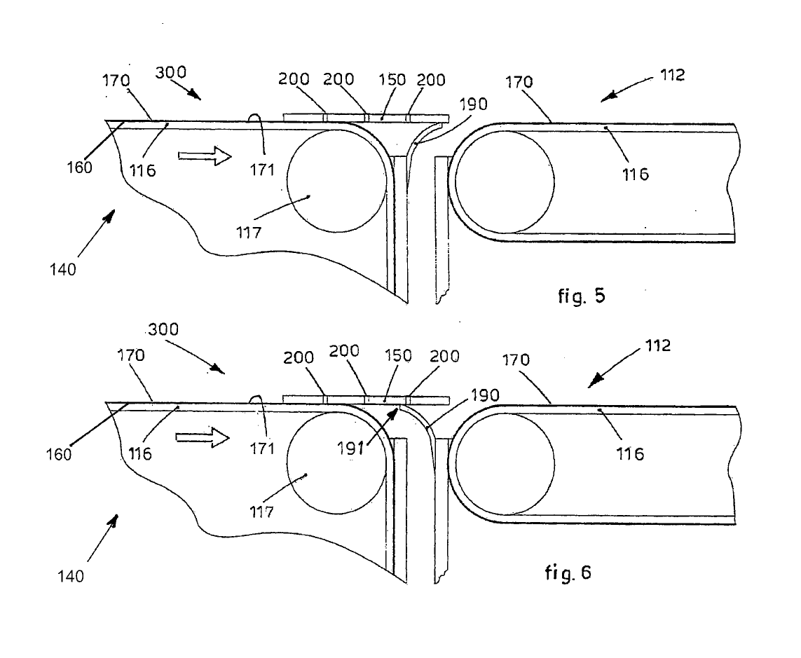

In another embodiment, the transport unit comprises a separator device that is disposed downstream of the print head. The separator device, such as the separation blade 190 shown in FIGS. 5 and 6, operates in cooperation with the transport device and functions to remove the printed print support from the adhesive surface layer. The separator device includes an element disposed in a fixed position with at least one edge 191 (FIG. 6) substantially adjacent to the contact surface 171 of the adhesive layer, so that an edge of the separator device can be disposed between the surface of the adhesive layer and a lower surface of the print support to detach the print support from the adhesive layer 170. In one embodiment, a mechanical actuator 119 (FIGS. 1 and 2) (e.g., electric motor), which is coupled to the conveyor belt 116, is used to move and/or position the substrate 150 and conveyor belt 116 relative to the separator device to cause the relative motion between the substrate 150 and the separator device to separate the substrate 150 from the adhesive layer 170 disposed on the conveyor belt 116. In one embodiment, the contact surface 171 of the adhesive layer 170 has an adhesive capacity, which is used to hold the print support to the conveyor belt of the transport shuttle, of between about 0.3 N/cm and about 5 N/cm.

FIG. 1 shows a lay-out of a plant 100 that is used to deposit print tracks 200 on a print support or substrate 150. The plant 100 comprises a transport unit 300 provided generally with an inlet conveyor 111, a rotary actuator unit 130, a silk-screen print head 102 and an outlet conveyor 112. The feed conveyors 111 and the outlet conveyor 112 are suitable to move the substrates 150 respectively into the rotary actuator unit 130 and out from the rotary actuator unit 130 in a direction of movement indicated by the arrows (i.e., direction F). The rotary actuator unit 130 comprises four print nests 140 that are angularly offset, and each print nest 140 is able to be moved between a position “1” in which it receives a substrate 150 from the inlet conveyor 111, a position “2” inside the silk-screen print head 102, a position “3” to transfer a processed substrate 150 to the outlet conveyor 112, and a position “4” which is an intermediate stage between positions “1” and “3”.

Suitable print nests which may be utilized include print nests available from Applied Materials Italia S.r.l., which can contain a lamp or other similar optical radiation device in order to rear-illuminate the substrate positioned upon it so that it can be easily inspected and centered. It is to be understood that other print nests sold by other manufacturers may be utilized as well.

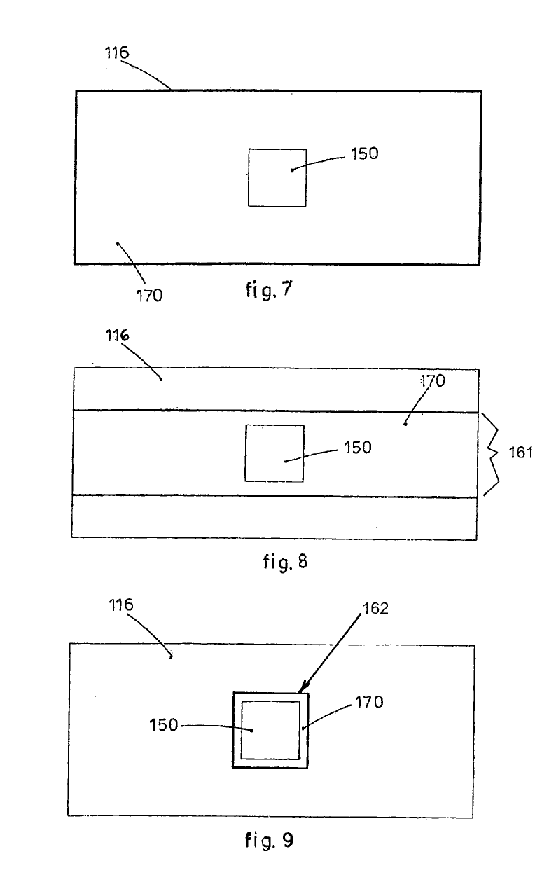

In the embodiment shown in FIG. 1, the feed conveyor 111, the outlet conveyor 112 and the print nests 140 may each comprise at least one conveyor belt 116 able to move the substrates 150 in the direction of working F or to move the substrates 150 into appropriate operating positions. FIGS. 1 and 2 illustrate a feed conveyor 111 and an outlet conveyor 112 that utilizes two conveyor belts 116 to support a substrate 150. However, this configuration is not intended to be limiting as to the scope of the invention described herein, since each of the conveyor assemblies in the plant 100 may comprise a single conveyor belt 116, as shown in FIGS. 7-9, that is adapted to support one or more substrates 150 during a transferring process. It is also contemplated that conveyors 111 and 112, instead of utilizing a conveyor belt 116, may comprise a mechanical and/or electromagnetic rail, on which the substrates 150 are able to move in a guided manner, for example supported by the print nests 140, that will then be moved between the four positions by the rotary actuator unit 130.

As shown in the embodiment of FIG. 2, a single conveyor assembly is provided with a belt 118 that transports the substrate 150 from position “1” in which a substrate 150 is introduced into the print head 102, a position “2” inside the print head 102, and a third position “3” in which the processed substrate 150 is discharged from the print head 102 and conveyed to other operating stations. In the embodiment of FIG. 2, the rotary actuator unit 130 is not utilized. It is contemplated that instead of the single conveyor belt 118, a mechanical and/or electromagnetic rail may be utilized, on which the substrates 150 are able to move in a guided manner, for example supported directly by the print nests 140.

In the embodiments shown in FIGS. 1 and 2, the conveyor belts 116 comprise at least a transport surface 160 over which the substrate 150 is able to be positioned during the transport and/or printing steps. Advantageously, the conveyor belt 116 is made of a water-repellent and non-transpiring material, such as for example a plastic material.

As shown schematically in FIG. 3, an adhesive layer 170 is disposed on the transport surface 160 of the conveyor belt 116 that is disposed in a print nest 140. The adhesive layer 170 is interposed between the transport surface 160 and the substrate 150, to retain the substrate on a contact surface 171 by an adhesive effect, and thus keeping the substrate 150 in the processing position on the contact surface 171 to prevent it from accidentally moving from such position during the transport and/or printing steps. Below the conveyor belt 116, on the side opposite the transport surface 160, a suction unit 180 is provided. The suction unit 180 is conformed and positioned as to create a pressure below atmospheric pressure, also defined as a pneumatic state of vacuum, below the transport surface 160 so that, thanks to the non-transpiring material of which the conveyor belt 116 and/or adhesive layer 170 is made or how the transport surface 160 is formed, the vacuum acts on the conveyor belt 116, keeping it, together with the substrate 150, in a predetermined operating position. In this way, no vacuum force acts on the substrate 150, also thanks to the fact that the conveyor belt 116 is not transpiring, and therefore there is no risk of the material from which the tracks 200 are formed from being accidentally drawn, or sucked, through the through holes 151 provided through the substrate 150.

In the embodiment shown in FIG. 4, an independent adhesive belt 175 (FIG. 4) is positioned on the transport surface 160 of the conveyor belt 116 that is disposed in a print nest 140. The adhesive belt 175 comprises a non-transpiring plastic film and is provided at least on the transport surface 160 with the adhesive layer 170. The adhesion of the adhesive belt 175 to the transport surface 160 of the conveyor belt 116 is obtained by a second adhesive layer provided on the lower surface of the adhesive belt 175. Alternatively, the conveyor belt 116 comprises a transpiring material, for example transpirable paper (e.g., cigarette paper). Due to the effect of the vacuum of the suction unit 180, the adhesive layer 170 is retained on, or pneumatically adhered to, the corresponding transport surface 160, while the substrate 150 remains temporarily adhered to the adhesive layer 170.

As shown schematically in the plan views of the transport surface 160 illustrated in FIGS. 7-9, whether the conveyor belt 116 has an adhesive layer 170 disposed thereon, or whether the conveyor belt 116 has an adhesive belt 175 (FIG. 4) disposed thereon, the disposition of the adhesive layer 170 can be on the whole usable positioning surface of the transport surface 160 of the conveyor belt 116 (FIG. 7), only on a central longitudinal part, or central region 161, of the usable positioning surface of the conveyor belt 116 (FIG. 8), or in localized regions 162 that correspond with or are near the positioning zone of the substrate 150 with respect to the whole usable positioning surface of the conveyor belt 116 (FIG. 9). One may choose the desired conveyor belt 116 configuration according to the type of printing to be carried out. In some types of printing, for example silk-screen printing, there is a risk that the screen print net (e.g., patterned mask used to lay down the printing tracks) can receive material from the adhesive layer 170, or deposit material on the adhesive layer 170, that is not covered by the substrate 150. In cases where portions of the adhesive layer left on the surface of the screen printing net can cause problems during the printing process, the solutions shown in FIGS. 8 and 9 are generally preferred.

With reference to FIGS. 5 and 6, at the outlet from the print nest 140, a separation blade 190 is disposed adjacent a terminal return pulley 117 of the conveyor belt 116 (i.e., the area where the substrate 150 is disassociated from the transport surface 160). The separation blade 190 has a substantially arched form so as to cooperate with a leading edge of the substrate 150, so as to guide and accompany the removal of the substrate 150 from the adhesive layer 170 and limit the risk of breaking the substrate 150. As shown in FIG. 5, the separation blade 190 is mechanically associated with the print nest 140. In the embodiment shown in FIG. 6, the separation blade 190 is mechanically associated with the first conveyor 111 and/or the second conveyor 112.

In one embodiment, the first conveyor 111 and/or the second conveyor 112 are automated substrate-handling devices which can be connected to a bigger production line, for example of the Softline™ instrument available from Applied Materials Italia S.r.l. which is connected to the plant 100. In one embodiment, the print heads 102 used in the plant 100 can be conventional silk-screen print heads available from Applied Materials Italia S.r.l., which are able to deposit the layers of tracks 200 in a desired pattern on the surface of a substrate 150 during a silk-screen printing process. It is to be understood that other automated substrate-handling devices and other silk-screen print heads, including those sold by other manufacturers, may be utilized.

In one embodiment, the print head 102 comprises a plurality of actuators 102A, (for example stepper motors or servo motors), which are in communication with a system controller 101 and are used to regulate the angular position and/or orientation (e.g., represented by reference numeral “A” in FIG. 3) of a silk-screen printing mask 102B (FIGS. 1 and 2) disposed in the print head 102 with respect to the substrate 150, which is positioned on the contact surface 171 of the adhesive layer 170, that is to be printed on. In one embodiment, the silk-screen printing mask is a foil or metal plate with plurality of openings, such as a plurality of holes, slits or other apertures formed therein, so as to define a pattern and a disposition of the silk-screen printed material on a surface of a substrate 150, which is disposed on the contact surface 171 of the adhesive layer 170. In one embodiment, the silk-screen printed material can comprise an ink or a conductive paste, an ink or a dielectric paste, a doping gel, an etching gel, one or more masking materials, or other conductive or dielectric materials that are disposed on the surface of substrate through the openings in the printing mask 102B. In general, the deposited silk-screened pattern disposed on the surface of a substrate 150 is aligned with the substrate 150 automatically by orienting the silk-screen printing mask 102B relative to the substrate 150 using the actuators 102A and the information received by the controller 101. The controller 101 is configured to receive information detected by the cameras (not shown), which can be disposed upstream and/or downstream of the print head 102 and over a contact surface of a conveyor in a transportation device.

In one embodiment, the print heads 102 are able to deposit a material containing metal or containing dielectric on a solar cell substrate with a width of between about 125 mm and 156 mm and a length between about 70 mm and 156 mm. In another embodiment, not shown, each print unit also comprises a drying oven to subject to treatment the material deposited on the substrate 150 by the print heads 102. In one embodiment, the substrates 150 are micro-crystalline silicon substrates used for solar cells. In another embodiment, the substrates 150 are ceramic green-tape substrates.

In one embodiment of the present invention, the plant 100 is a silk-screen printing plant and the print heads 102 include silk-screen printing components which are configured to silk-screen print a layer of tracks 200 of material according to a pattern on a surface of the substrate 150. In another embodiment, the plant 100 is an ink jet printing plant and the print heads 102 include ink jet printing components, which are configured to deposit a layer of tracks 200 of material according to a pattern on a surface of the substrate 150. In another embodiment, the plant 100 is a processing plant that includes components for removing material in the print head 102, like a laser for the ablation or etching of one or more regions on a substrate 150. In another embodiment, the plant 100 can comprise other substrate processing modules which require precise movement and positioning of the substrates 150 for processing.

The controller 101 facilitates the control and automation of the whole plant 100 and can comprise a central processing unit (CPU) (not shown), a memory (not shown), and auxiliary circuits (or I/O) (not shown). The CPU can be of any type of processor for computers that are used in industrial regulations to control different chamber processes and hardware devices (such as conveyors, detectors, motors, fluid delivery devices, etc.) and to monitor the system and chamber processes (like the position of the substrate, processing times, signal detectors, etc.). The memory is connected to the CPU, and can be one or more from among those easily available, such as a random access memory (RAM), a read-only memory (ROM), floppy disk, hard disk, or any other form of digital storage, local or remote. The software instructions and the data can be encoded and memorized in the memory to command the CPU. The auxiliary circuits too are connected to the CPU to help the processor in a conventional manner. The auxiliary circuits can include cache circuits, feed circuits, clock circuits, input/output circuits, subsystems and suchlike. A program (or computer instructions) readable by the controller 101 determines which tasks can be performed on a substrate 150. Preferably, the program is a software readable by the controller 101, which comprises a code to generate and memorize at least information on the position of the substrate 150, the sequence of movement of the various components controlled, information from the TV cameras, and any other corresponding combination.

In the configuration of the plant 100 shown in FIG. 1, each feed conveyor 111 feeds the relative substrates 150 in the direction F to the print nests 140 of the rotary actuator unit 130, so as to position the substrates 150 under the relative print head 102, so that a process can be started (for example silk-screen printing, ink jet printing, removal of material) on the substrates 150. Once the first layer of tracks 200 has been deposited, the substrates 150 are sent to subsequent processing steps, for example drying and/or further printing steps, according to requirements. With the present invention, the presence of the adhesive layer 170 on the transport surface 160 of the conveyor belt 116 ensure the substrate 150 maintains a predetermined position with respect to the conveyor belt 116 during all the transport steps, so as to optimize possible controls and operating corrections to be made so as to obtain a high printing quality.

It is to be understood that, in association with the print head 102, TV cameras may be provided, and also rotation members and/or correction members, not shown, to verify and modify the position of the substrates 150 before and/or after each operating passage through the print head 102. It is clear, however, that modifications and/or additions of parts or steps may be made to the transport unit 300 and the method as described heretofore, without departing from the field and scope of the present invention. For example, it is to be understood that each print unit may include two or more print heads 102, depending on specific operating requirements. It also is to be understood that the conveyor belt 116 may comprise a plurality of separate portions of its transport surface 160 on which the adhesive layer 170 is applied independently, so that a relative substrate 150 can be disposed on each portion. Additionally, each portion of the conveyor belt 116 may be independently movable with respect to the adjacent portions, so as to allow a possible specific adjustment of each substrate 150 before the printing steps.

Although the present invention has been described with reference to specific examples, a person of skill in the art shall certainly be able to achieve many other equivalent forms of unit for transporting a print support in a plant for depositing print tracks on the print support and relative transport method, having the characteristics as set forth in the claims and hence all coming within the field of protection defined thereby.

While the foregoing is directed to embodiments of the present invention, other and further embodiments of the invention may be devised without departing from the basic scope thereof, and the scope thereof is determined by the claims that follow.

1. A transportation apparatus, comprising:
a transport device having a transport surface;
an adhesive layer disposed over at least a portion of the transport surface, wherein the adhesive layer has a contact surface on which at least a portion of a substrate can be received;
a separation device having an edge that is positioned to separate a substrate that is disposed on the contact surface; and
a mechanical actuator that is configured to move the adhesive layer relative to the separation device.

2. The transportation apparatus of claim 1, wherein the contact surface of the adhesive layer has an adhesive capacity from about 0.3 N/cm to about 5 N/cm.

3. The transportation apparatus of claim 2, further comprising a suction element disposed adjacent to the transport surface, and configured to expose a side of the transport device that is opposite to the transport surface to a pressure below atmospheric pressure.

4. The transportation apparatus of claim 3, wherein the transport device comprises a conveyor belt.

5. The transportation apparatus of claim 1, further comprising a suction element disposed below the transport surface, and configured to expose a side of the transport device that is opposite to the transport surface to a pressure below atmospheric pressure.

6. The transportation apparatus of claim 5, wherein the transport device comprises a conveyor belt.

7. The transportation apparatus of claim 1, wherein the transport device comprises a conveyor belt.

8. The transportation apparatus of claim 7, wherein the conveyor belt comprises a water-repellent and non-transpiring material.

9. The transportation apparatus of claim 1, wherein the transport device further comprises an adhesive belt that is disposed on the transport surface of a conveyor belt, and having surface on which at least a portion on which the adhesive layer is disposed.

10. The transportation apparatus of claim 9, wherein the conveyor belt comprises a transpirable material.

11. The transportation apparatus of claim 1, wherein the transport device comprises:
a transport shuttle able to support and transport a substrate at least through a print station; and
a conveyor belt comprising the transport surface on which the adhesive layer is disposed.

12. The transportation apparatus of claim 1, further comprising
a print station comprising a printing mask and an actuator that is adapted to adjust the position of the printing mask relative to the contact surface of the adhesive layer.

13. A method for transporting a substrate, comprising:
disposing a substrate on a contact surface of an adhesive layer that is disposed over at least a portion of a transport surface of a transport device;
moving the substrate and the transport device towards a print head;
positioning a printing mask disposed in the print head relative to the substrate using an actuator; and
separating the substrate from the adhesive layer by causing an edge of a separation device to be disposed between the adhesive layer and the substrate.

14. The method of claim 13, further comprising:
depositing a material onto a surface of the substrate by disposing the material through one or more openings formed in the printing mask.

15. The method of claim 13, wherein separating the substrate from the adhesive layer further comprises moving the substrate and adhesive layer relative to the edge of the separation device at some time during the process of moving the adhesive layer and the substrate relative to the edge of the separation device.

16. The method of claim 13, further comprising
positioning the substrate disposed on the adhesive layer adjacent to the printing mask; and
forming a pressure below atmospheric pressure on a side of the transport device that is opposite to the transport surface using a suction element.

17. The method of claim 17, further comprising:
depositing material onto a surface of the substrate by disposing a material through one or more holes formed in the printing mask.

18. The method of claim 13, wherein the contact surface of the adhesive layer has an adhesive capacity from about 0.3 N/cm to about 5 N/cm.

19. The method of claim 13, wherein the transport device comprises a conveyor belt.
